(19) United States
(12) Patent Application Publication
(10) Pub. No.: US 2025/0233379 A1
(43) Pub. Date: Jul. 17, 2025

(54) DISCHARGE ELECTRODE, MANUFACTURING METHOD FOR DISCHARGE ELECTRODE, AND MANUFACTURING METHOD FOR ELECTRONIC DEVICE

(71) Applicant: GIGAPHOTON INC., Tochigi (JP)

(72) Inventors: Rei TAKENAKA, Oyama-shi (JP); Yoichi SASAKI, Oyama-shi (JP)

(73) Assignee: GIGAPHOTON INC., Tochigi (JP)

(21) Appl. No.: 19/171,116

(22) Filed: Apr. 4, 2025

Related U.S. Application Data
(63) Continuation of application No. PCT/JP2022/042632, filed on Nov. 16, 2022.

(51) Int. Cl. H01S 3/038

(52) U.S. Cl. CPC H01S 3/0385

(57) ABSTRACT

A discharge electrode to be used in a gas laser device for exciting a laser gas containing fluorine by discharge includes a cathode having an elongated cathode discharge surface, and an anode having an elongated anode discharge surface and arranged in a posture in which the anode discharge surface faces the cathode discharge surface. Here, a large number of recesses are formed on the cathode discharge surface in an initial state, and a large number of recesses are not formed on the anode discharge surface in the initial state.

### CROSS-REFERENCE TO RELATED APPLICATIONS

The present application claims the benefit of International Application No. PCT/JP2022/042632, filed on Nov. 16, 2022, the entire contents of which are hereby incorporated by reference.

### BACKGROUND

### 1. Technical Field

The present disclosure relates to a discharge electrode, a manufacturing method for a discharge electrode, and a manufacturing method for an electronic device.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 μm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be line-narrowed to the extent that the chromatic aberration can be ignored. For this purpose, there is a case in which a line narrowing module (LNM) including a line narrowing element (etalon, grating, and the like) is provided in a laser resonator of the gas laser device to line-narrow a spectral line width. In the following, a gas laser device with a narrowed spectral line width is referred to as a line narrowing gas laser device.

### LIST OF DOCUMENTS

### Patent Documents

Patent Document 1: Japanese Patent Application Publication No. 2004-179599
Patent Document 2: Japanese Patent Application Publication No. 2004-146579

### SUMMARY

A discharge electrode, according to an aspect of the present disclosure, to be used in a gas laser device for exciting a laser gas containing fluorine by discharge includes a cathode having an elongated cathode discharge surface, and an anode having an elongated anode discharge surface and arranged in a posture in which the anode discharge surface faces the cathode discharge surface. Here, a large number of recesses are formed on the cathode discharge surface in an initial state, and a large number of recesses are not formed on the anode discharge surface in the initial state.

A discharge electrode, according to an aspect of the present disclosure, to be used in a gas laser device for exciting a laser gas containing fluorine by discharge includes a cathode having an elongated cathode discharge surface, and an anode having an elongated anode discharge surface and arranged in a posture in which the anode discharge surface faces the cathode discharge surface. Here, a large number of recesses are formed on the cathode discharge surface in an initial state, and a coating layer is formed on the recesses.

A manufacturing method for a discharge electrode according to an aspect of the present disclosure includes a first process of forming a large number of recesses on an elongated cathode discharge surface, and a second process of forming a coating layer on an inner peripheral surface of each of the recesses. Here, the discharge electrode to be used in a gas laser device for exciting a laser gas containing fluorine by discharge includes a cathode having the cathode discharge surface, and an anode having an elongated anode discharge surface and arranged in a posture in which the anode discharge surface faces the cathode discharge surface.

A manufacturing method for an electronic device according to an aspect of the present disclosure includes generating laser light using a gas laser device in which a laser gas including fluorine is excited by discharge using a discharge electrode, outputting the laser light to an exposure apparatus, and exposing a photosensitive substrate to the laser light in the exposure apparatus to manufacture an electronic device. Here, the discharge electrode includes a cathode having an elongated cathode discharge surface, and an anode having an elongated anode discharge surface and arranged in a posture in which the anode discharge surface faces the cathode discharge surface. A large number of recesses are formed on the cathode discharge surface in an initial state, and a large number of recesses are not formed on the anode discharge surface in the initial state.

A manufacturing method for an electronic device according to an aspect of the present disclosure includes generating laser light using a gas laser device in which a laser gas including fluorine is excited by discharge using a discharge electrode, outputting the laser light to an exposure apparatus, and exposing a photosensitive substrate to the laser light in the exposure apparatus to manufacture an electronic device. Here, the discharge electrode includes a cathode having an elongated cathode discharge surface, and an anode having an elongated anode discharge surface and arranged in a posture in which the anode discharge surface faces the cathode discharge surface. A large number of recesses are formed on the cathode discharge surface in an initial state, and a coating layer is formed on the recesses.

### BRIEF DESCRIPTION OF THE DRAWINGS

Embodiments of the present disclosure will be described below merely as examples with reference to the accompanying drawings.

FIG. 1 is a side view schematically showing the configuration of a gas laser device according to a comparative example.

FIG. 2 is a sectional view schematically showing the configuration of the gas laser device according to the comparative example.

FIG. 3 is a schematic view of a discharge electrode according to the comparative example.

FIG. 4 is a graph showing a change over time in fluorine consumption amount in a laser gas.

FIG. 5 is a schematic view of a discharge electrode according to a first embodiment.

FIG. 6 is a view showing recesses on a cathode discharge surface of the discharge electrode according to the first embodiment.

FIG. 7 is a sectional view of the cathode discharge surface.

FIG. 8 is a schematic diagram of a manufacturing process of the gas laser device.

FIG. 9 is a diagram showing a procedure of forming recesses on the cathode discharge surface.

FIG. 10 is a diagram showing a change over time of a state of the cathode discharge surface.

FIG. 11 is a view showing an overall surface shape of the cathode discharge surface and an anode discharge surface.

FIG. 12 is a view showing a coating layer of recesses on the cathode discharge surface.

FIG. 13 is a diagram showing a procedure of a coating process.

FIG. 14 is a diagram showing an example of the discharge electrode according to a second embodiment.

FIG. 15 is a diagram showing another example of the discharge electrode according to the second embodiment.

FIG. 16 is a diagram schematically showing a configuration example of an exposure apparatus.

### DESCRIPTION OF EMBODIMENTS

### <Contents>

1. Comparative example
   1.1 Configuration
   1.2 Operation
   1.3 Problem
2. First Embodiment
   2.1 Configuration and operation
   2.2 Manufacturing method for discharge electrode
   2.3 Effect
   2.4 Modification of first embodiment
      2.4.1 First modification (surface shape of cathode discharge surface)
         2.4.1.1 Relationship between surface shape of cathode discharge surface and wear amount of cathode
         2.4.1.2 Relationship between surface shape of cathode discharge surface and surface shape of anode discharge surface
      2.4.2 Second modification (coating on recess)
         2.4.2.1 Configuration and effect of coating layer
         2.4.2.2 Forming method of coating layer
3. Second Embodiment
   3.1 Configuration
   3.2 Manufacturing method for discharge electrode
   3.3 Effect
4. Other modification
5. Manufacturing method for electronic device

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. COMPARATIVE EXAMPLE

First, a comparative example of the present disclosure will be described. The comparative example of the present disclosure is an example recognized by the applicant as known only by the applicant, and is not a publicly known example admitted by the applicant.

### 1.1 Configuration

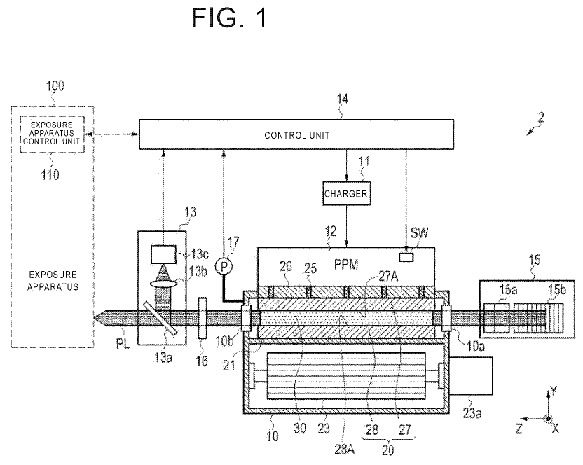

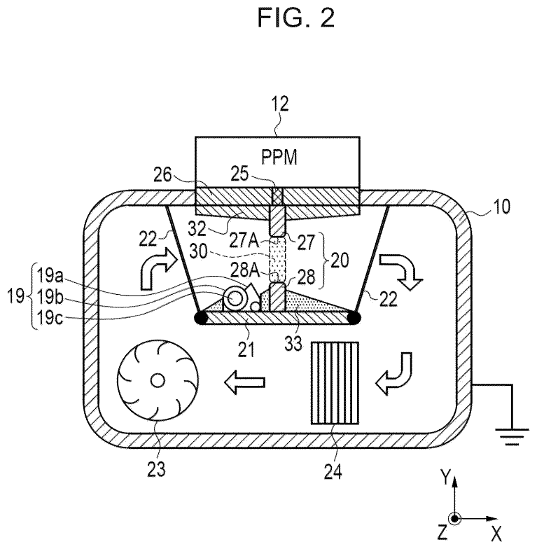

The configuration of a gas laser device 2 according to the comparative example will be described using FIGS. 1 and 2. FIG. 1 schematically shows the configuration of the gas laser device 2. FIG. 2 is a sectional view of the gas laser device 2 shown in FIG. 1 viewed from a Z direction. The gas laser device 2 is a discharge-excitation-type gas laser device that causes excitation of a laser gas by discharge, and is, for example, an excimer laser device.

In FIG. 1, the travel direction of pulse laser light PL output from the gas laser device 2 is defined as the Z direction. A discharge direction to be described later is defined as a Y direction. A direction orthogonal to the Z direction and the Y direction is defined as an X direction.

The gas laser device 2 includes a laser chamber 10, a charger 11, a pulse power module (PPM) 12, a pulse energy measurement unit 13, a control unit 14, a pressure sensor 17, and a laser resonator. The laser resonator is configured of a line narrowing module 15 and an output coupling mirror (output coupler: OC) 16.

The laser chamber 10 is, for example, a metal container made of aluminum metal plated with nickel on the surface thereof. As shown in FIGS. 1 and 2, in the laser chamber 10, a discharge electrode 20, a ground plate 21, wirings 22, a fan 23, a heat exchanger 24, a preionization discharge unit 19, an electrically insulating guide 32, and a metal damper 33 are provided. The preionization discharge unit 19 includes a preionization outer electrode 19a, a dielectric pipe 19b, and a preionization inner electrode 19c.

The laser gas as a laser medium is enclosed in the laser chamber 10. The laser gas includes, for example, argon, krypton, xenon, or the like as a rare gas, neon, helium, or the like as a buffer gas, and fluorine as a halogen gas.

Further, an opening is formed in the laser chamber 10. An electrically insulating plate 26 is provided so as to block the opening. A plurality of feedthroughs 25 are embedded in the electrically insulating plate 26. The PPM 12 is arranged on the electrically insulating plate 26. The laser chamber 10 is grounded.

The discharge electrode 20 includes a pair of electrodes of a cathode 27 and an anode 28. The cathode 27 has a discharge surface 27A on one surface, and the anode 28 has a discharge surface 28A on one surface. The cathode 27 and the anode 28 are arranged so that the discharge surface 27A and the discharge surface 28A face each other in the laser chamber 10. The space between the discharge surface 27A of the cathode 27 and the discharge surface 28A of the anode 28 is referred to as a discharge space 30. The cathode 27 is supported by the electrically insulating plate 26 on a surface opposite to the discharge surface 27A. The anode 28 is supported by the ground plate 21 on a surface opposite to the discharge surface 28A. In the present specification, to distinguish the discharge surface 27A of the cathode 27 and the discharge surface 28A of the anode 28, the discharge surface 27A is referred to as a cathode discharge surface 27A and the discharge surface 28A is referred to as an anode discharge surface 28A.

The feedthroughs 25 are connected to the cathode 27. Further, the feedthroughs 25 are connected to the PPM 12.

The ground plate 21 is connected to the laser chamber 10 via the wirings 22. The laser chamber 10 is grounded. The ground plate 21 is grounded via the wirings 22. An end part of the ground plate 21 in the Z direction is fixed to the laser chamber 10.

The fan 23 is a cross flow fan for circulating the laser gas in the laser chamber 10, and is arranged on the opposite side of the discharge space 30 with respect to the ground plate 21. A motor 23a for rotationally driving the fan 23 is connected to the laser chamber 10.

The laser gas blown out from the fan 23 flows into the discharge space 30. The flow direction of the laser gas flowing into the discharge space 30 is substantially parallel to the X direction. The laser gas flowing out from the discharge space 30 may be sucked into the fan 23 via the heat exchanger 24. The heat exchanger 24 exchanges heat between a cooling medium supplied to the inside of the heat exchanger 24 and the laser gas.

The electrically insulating guide 32 is arranged on a surface of the electrically insulating plate 26 facing the discharge space 30 so as to sandwich the cathode 27. The electrically insulating guide 32 is formed in a shape to guide the flow of the laser gas so that the laser gas from the fan 23 efficiently flows between the cathode 27 and the anode 28. The electrically insulating guide 32 and the electrically insulating plate 26 are made of, for example, ceramics such as alumina (Al₂O₃) having low reactivity with a fluorine gas.

The metal damper 33 is arranged on a surface of the ground plate 21 facing the discharge space 30 so as to sandwich the anode 28. The metal damper 33 is made of, for example, a porous nickel metal having low reactivity with the fluorine gas.

The laser chamber 10 is provided with a laser gas supply device (not shown) and a laser gas exhaust device (not shown). The laser gas supply device includes a valve and a flow rate control valve, and is connected to a gas cylinder accommodating the laser gas. The laser gas exhaust device includes a valve and an exhaust pump.

Windows 10a, 10b for outputting light generated in the laser chamber 10 to the outside are provided at end parts of the laser chamber 10, respectively. The laser chamber 10 is arranged such that the optical path of the optical resonator passes through the discharge space 30 and the windows 10a, 10b.

The line narrowing module 15 includes a prism 15a and a grating 15b. The prism 15a transmits the light output from the laser chamber 10 through the window 10a toward the grating 15b while expanding the beam width of the light.

The grating 15b is arranged in the Littrow arrangement so that the incident angle and the diffraction angle are the same. The grating 15b is a wavelength selection element that selectively extracts light having a wavelength near a particular wavelength in accordance with the diffraction angle. The spectral width of the light returning from the grating 15b to the laser chamber 10 via the prism 15a is line-narrowed.

The output coupling mirror 16 transmits a part of the light output from the laser chamber 10 through the window 10b, and reflects the other part back into the laser chamber 10. The surface of the output coupling mirror 16 is coated with a partial reflection film.

Light output from the laser chamber 10 reciprocates between the line narrowing module 15 and the output coupling mirror 16, and is amplified each time the light passes through the discharge space 30. A part of the amplified light is output as the pulse laser light PL via the output coupling mirror 16. The pulse laser light PL is an example of the “laser light” according to the technology of the present disclosure.

The pulse energy measurement unit 13 is arranged on the optical path of the pulse laser light PL output via the output coupling mirror 16. The pulse energy measurement unit 13 includes a beam splitter 13a, a light concentrating optical system 13b, and an optical sensor 13c.

The beam splitter 13a transmits the pulse laser light PL with a high transmittance and reflects a part of the pulse laser light PL toward the light concentrating optical system 13b. The light concentrating optical system 13b concentrates the light reflected by the beam splitter 13a on a light receiving surface of the optical sensor 13c. The optical sensor 13c measures the pulse energy of the light concentrated on the light receiving surface, and outputs the measurement value to the control unit 14.

The pressure sensor 17 detects the gas pressure in the laser chamber 10, and outputs the detection value to the control unit 14. The control unit 14 determines the gas pressure of the laser gas in the laser chamber 10 based on the detection value of the gas pressure and the charge voltage of the charger 11.

The charger 11 is a high voltage power source that supplies the charge voltage to the charging capacitor included in the PPM 12. The PPM 12 includes a solid-state switch SW controlled by the control unit 14. When the solid-state switch SW is turned ON from OFF, the PPM 12 generates a high voltage pulse from the electric energy held in the charging capacitor and applies the high voltage pulse to the discharge electrode 20.

The control unit 14 is a processor that transmits and receives various signals to and from an exposure apparatus control unit 110 provided in the exposure apparatus 100. For example, the exposure apparatus control unit 110 transmits, to the control unit 14, the target pulse energy of the pulse laser light PL to be output to the exposure apparatus 100, a signal related to the target oscillation timing, and the like.

The control unit 14 generally controls operation of each component of the gas laser device 2 based on various signals transmitted from the exposure apparatus control unit 110, the measurement value of the pulse energy, the detection value of the gas pressure, and the like.

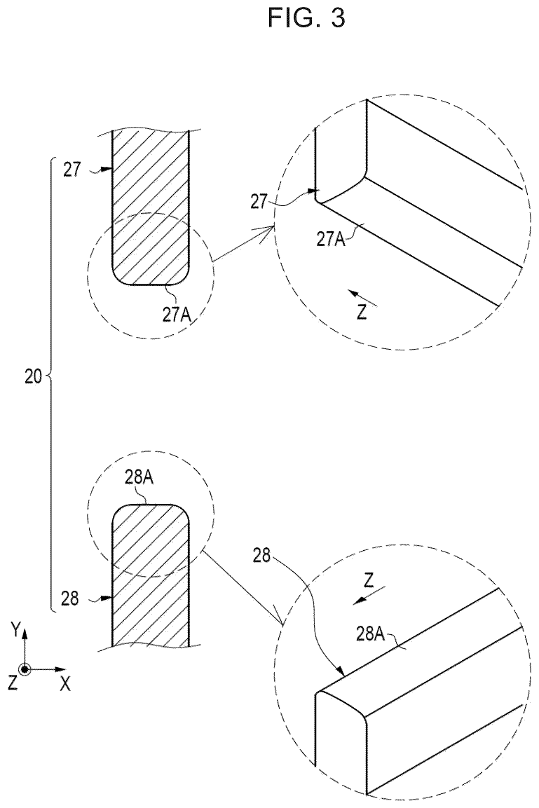

FIG. 3 shows the configuration of the discharge electrode 20. In FIG. 3, the preionization discharge unit 19, the electrically insulating guide 32, the metal damper 33, and the like are not shown.

The cathode 27 and the anode 28 each have an substantially rectangular parallelepiped shape elongated with the Z direction being the longitudinal direction. The cathode discharge surface 27A and the anode discharge surface 28A also each have a shape elongated with the Z direction being the longitudinal direction. The cathode discharge surface 27A and the anode discharge surface 28A each have a width direction in the X direction perpendicular to the longitudinal direction, and face each other in the Y direction perpendicular to the longitudinal direction. The cathode 27 and the anode 28 are made of a metal such as copper.

The surface shape of the cathode discharge surface 27A is planar or curved. When the cathode discharge surface 27A is a curved surface, it is a curved surface convexed toward the opposing anode discharge surface 28A. The sectional shape of the cathode discharge surface 27A in the width direction, that is, the sectional shape in an XY plane becomes a straight line when the cathode discharge surface 27A is planar, and becomes a curved line such as an ellipse when the cathode discharge surface 27A is a curved surface. The cathode discharge surface 27A is formed as a smooth surface without irregularities in an initial state. Here, the initial state refers to a state of a stage before assembling the laser chamber 10 using components such as the discharge electrode 20 in a device manufacturing process of the gas laser device 2. Details of the pre-assembly stage will be described later.

The anode discharge surface 28A is also similar to the cathode discharge surface 27A. That is, the surface shape of the anode discharge surface 28A is planar or curved as being convexed toward the cathode discharge surface 27A, and the sectional shape is configured as a straight line or a curved line such as an ellipse, or the like. Further, the anode discharge surface 28A is also formed as a smooth surface without irregularities in an initial state.

### 1.2 Operation

The control unit 14 controls the laser gas supply device to supply the laser gas into the laser chamber 10, and drives the motor 23a to rotate the fan 23. Accordingly, the laser gas circulates in the laser chamber 10.

The control unit 14 receives signals related to a target pulse energy Et and the target oscillation timing transmitted from the exposure apparatus control unit 110.

The control unit 14 sets a charge voltage Vhv corresponding to the target pulse energy Et in the charger 11. The control unit 14 stores the value of the charge voltage Vhv set in the charger 11. The control unit 14 operates the solid-state switch SW of the PPM 12 in synchronization with the target oscillation timing.

When the solid-state switch SW of the PPM 12 is turned ON from OFF, a voltage is applied between the preionization inner electrode 19c and the preionization outer electrode 19a of the preionization discharge unit 19 and between the cathode 27 and the anode 28. As a result, corona discharge occurs in the preionization discharge unit 19, and ultraviolet (UV) light is generated. When the laser gas in the discharge space 30 is irradiated with the UV light, the laser gas is preionized.

Thereafter, when the voltage between the cathode 27 and the anode 28 reaches a breakdown voltage, main discharge occurs in the discharge space 30. When the discharge direction of main discharge is defined as a direction in which electrons flow, the discharge direction is the direction from the cathode 27 toward the anode 28. When main discharge occurs, the laser gas in the discharge space 30 is excited to emit light. Main discharge is arc discharge, and is hereinafter simply referred to as discharge.

The metal damper 33 suppresses an acoustic wave generated by discharge from being reflected and returning to the discharge space 30 again. Further, as the laser gas circulates in the laser chamber 10, discharge products generated in the discharge space 30 moves downstream.

The light emitted from the laser gas is reflected by the line narrowing module 15 and the output coupling mirror 16 and reciprocates in the laser resonator, thereby performing laser oscillation. The light line-narrowed by the line narrowing module 15 is output from the output coupling mirror 16 as the pulse laser light PL.

A part of the pulse laser light PL output from the output coupling mirror 16 enters the pulse energy measurement unit 13. The pulse energy measurement unit 13 measures a pulse energy E of the entering pulse laser light PL, and outputs the measurement value to the control unit 14.

The control unit 14 stores the measurement value of the pulse energy E measured by the pulse energy measurement unit 13. The control unit 14 calculates a difference ΔE between the measurement value of the pulse energy E and the target pulse energy Et. The control unit 14 performs feedback control on the charge voltage Vhv based on the difference AE so that the measurement value of the pulse energy E becomes the target pulse energy Et.

When the charge voltage Vhv is higher than a maximum value of an allowable range, the control unit 14 controls the laser gas supply device to supply the laser gas into the laser chamber 10 until a predetermined pressure is reached. Further, when the charge voltage Vhv is lower than a minimum value of the allowable range, the control unit 14 controls the laser gas exhaust device to exhaust the laser gas from the laser chamber 10 until a predetermined pressure is reached.

### 1.3 Problem

One of the factors that determine the useful life of the laser chamber 10 is the wear of the cathode 27. The cause of the wear of the cathode 27 is presumed as follows. When discharge starts, ionized particles in the laser gas collide with the cathode discharge surface 27A, so that copper, which is the material of the cathode 27, is repelled from the cathode discharge surface 27A. It is considered that the wear of the cathode 27 occurs because the cathode discharge surface 27A is physically scraped due to such phenomena as sputtering on the cathode discharge surface 27A.

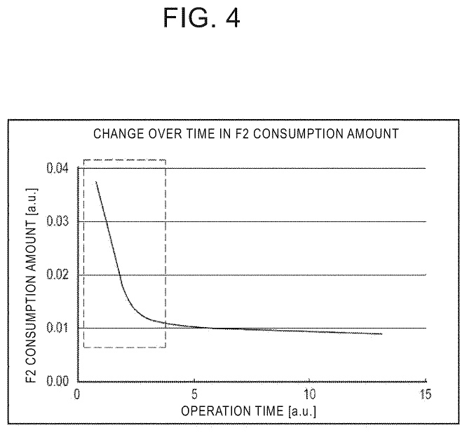

FIG. 4 is a graph showing a change over time in the fluorine consumption amount (indicated by F2 in FIG. 4) in the laser gas from immediately after the start of operation of the laser chamber 10. In FIG. 4, the horizontal axis represents the operation time of the laser chamber 10, and the vertical axis represents the fluorine consumption amount. As indicated by a dotted rectangle in FIG. 4, the fluorine consumption amount is relatively large at the initial stage of the operation including immediately after the start of the operation. Thereafter, the fluorine consumption amount decreases with the passage of time, and eventually enters a stable period in which the fluorine consumption amount is small. It is estimated that there is a positive correlation between the fluorine consumption amount and the wear amount of the cathode 27. This is because the copper repelled from the cathode discharge surface 27A during discharge is dusted and combined with fluorine in the laser gas, and fluorine in the laser gas is consumed by bonding with the dusted copper.

The fact that the fluorine consumption amount in the laser gas is large means that a generation amount of dusted copper is large, that is, the scrapped amount of the cathode discharge surface 27A is large, and wear of the cathode 27 is severe. When estimated from the change over time of the fluorine consumption amount shown in FIG. 4, the wear amount of the cathode 27 is large at the initial stage of operation, but gradually decreases with the passage of operation time, and is considered to be stable in a state of being less than that at the initial stage of operation.

In order to extend the lifetime of the laser chamber 10, it is required to decrease the wear amount of the cathode 27 at the initial stage of operation.

### 2. FIRST EMBODIMENT

### 2.1 Configuration and Operation

The discharge electrode 20 according to a first embodiment of the present disclosure is also used in the gas laser device 2 in a similar manner as the discharge electrode 20 according to the comparative example. The gas laser device 2 in which the discharge electrode 20 according to the first embodiment is used has a similar configuration as the gas laser device 2 according to the comparative example except that the configuration of the discharge electrode 20 is different, and the operation is also similar.

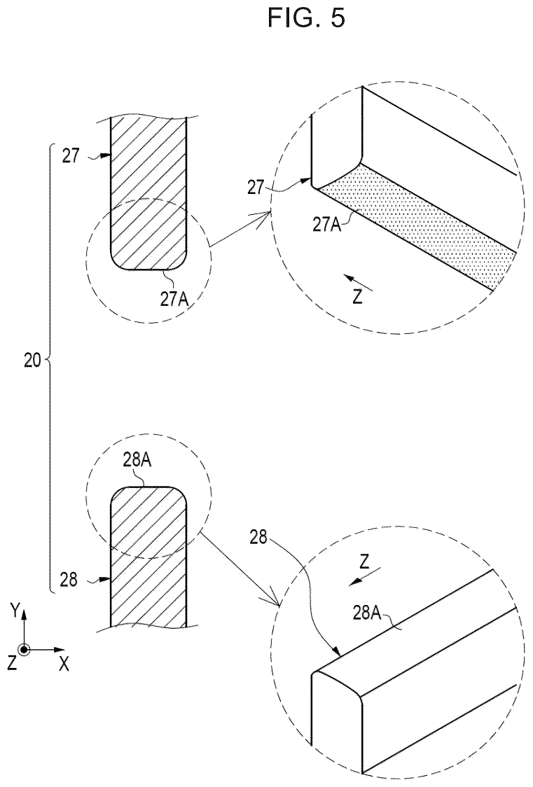

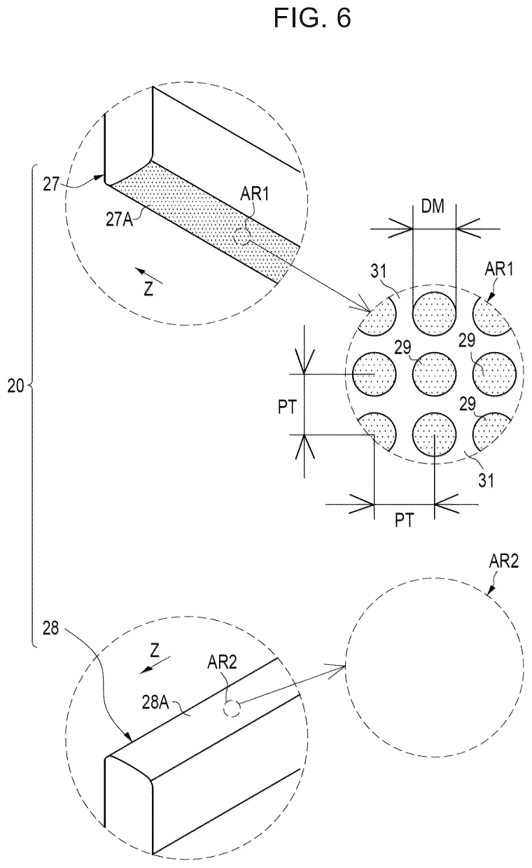

FIGS. 5 and 6 schematically show the configuration of the discharge electrode 20 according to the first embodiment. In FIG. 6, a reference numeral AR1 indicates a region of a part of the discharge surface 27A. A reference numeral AR2 indicates a region of a part of the discharge surface 28A. As shown in the enlarged view of the region AR1, in the discharge electrode 20 according to the present embodiment, a large number of recesses 29 (see FIG. 6) are formed on the cathode discharge surface 27A in the initial state. Here, the large number of recesses 29 refer to recesses having a density of 100 pieces/mm² or more. Hatching of the cathode discharge surface 27A indicates a region where the recesses 29 are formed. In the present embodiment, the large number of recesses 29 are formed in the entire region of the cathode discharge surface 27A.

On the other hand, as shown in an enlarged view of the region AR2, any recess 29 is not formed on the anode discharge surface 28A in the initial state. More specifically, the anode discharge surface 28A is a smooth surface having no recess 29 and a surface roughness Ra smaller than 25.

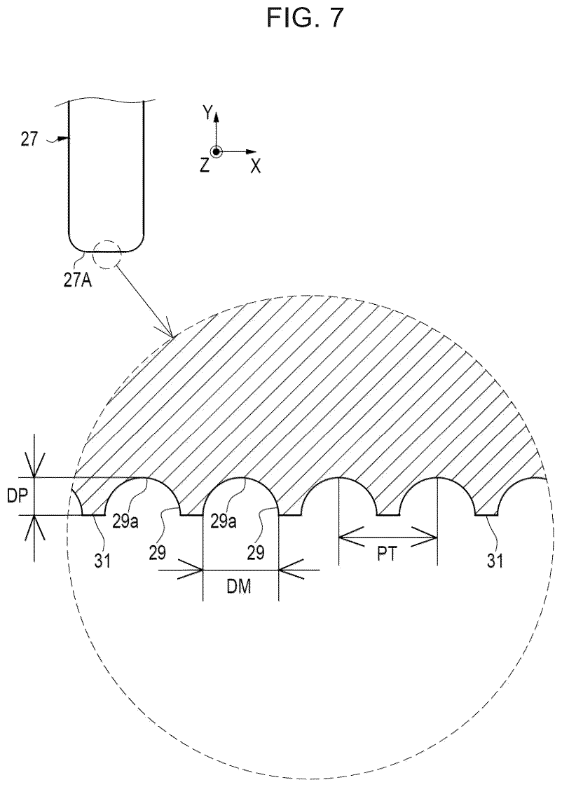

As shown in FIG. 6, in the present embodiment, the planar shape of the recess 29 is circular. FIG. 7 is an enlarged view of a cross section of the cathode discharge surface 27A in the width direction. In the present embodiment, a diameter DM of the recess 29 is 20 to 100 μm, and a depth DP of the recess 29 is 5 to 30 μm. Further, an inner peripheral surface 29a of the recess 29 has a curved shape. The shape of the inner peripheral surface 29a is preferably spherical. Further, the large number of recesses 29 are regularly arranged. In the present embodiment, the arrangement of the large number of recesses 29 is a square arrangement in which the vertical and horizontal intervals PT between adjacent recesses 29 are equal.

The width of the cathode discharge surface 27A is about several millimeters. In the cathode discharge surface 27A, the number of the recesses 29 per unit area is 100 pieces/mm² or more, preferably 1000 pieces/mm² or more, and more preferably 3000 pieces/mm² or more. Further, it is preferable that the recesses 29 are formed at a uniform density over the entire region of the cathode discharge surface 27A.

Since the cathode discharge surface 27A is a smooth surface before the recesses 29 are formed, the periphery of the recesses 29 becomes convex portions 31 which are relatively higher than the recesses 29 owing to that a large number of recesses 29 are formed. Thus, the cathode discharge surface 27A has fine irregularities formed by the large number of recesses 29 and the convex portions 31 around the recesses 29.

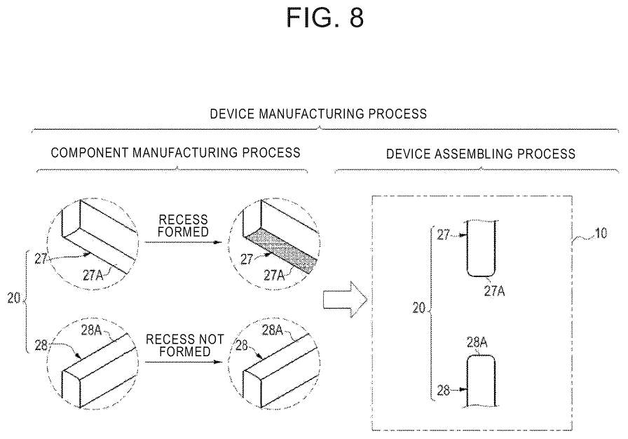

FIG. 8 schematically shows the outline of a device manufacturing process of the gas laser device 2. As shown in FIG. 8, the device manufacturing process includes a component manufacturing process for manufacturing components such as the discharge electrode 20 and a device assembling process for assembling the manufactured components. In the component manufacturing process, the recesses 29 are formed on the cathode discharge surface 27A. On the other hand, the recesses 29 are not formed on the anode discharge surface 28A.

In the device assembling process, components such as the discharge electrode 20 manufactured in the component manufacturing process are supplied, and the laser chamber 10 is assembled using the supplied components such as the discharge electrode 20. A pre-assembling stage refers to a stage after the discharge electrode 20 is manufactured in the component manufacturing process and before the laser chamber 10 is assembled in the device assembling process. The state of the discharge electrode 20 at this stage is the “initial state” according to the technology of the present disclosure. That is, in the discharge electrode 20 according to the first embodiment, in the initial state, the large number of recesses 29 are formed on the cathode discharge surface 27A, and the recesses 29 are not formed on the anode discharge surface 28A.

### 2.2 Manufacturing Method for Discharge Electrode

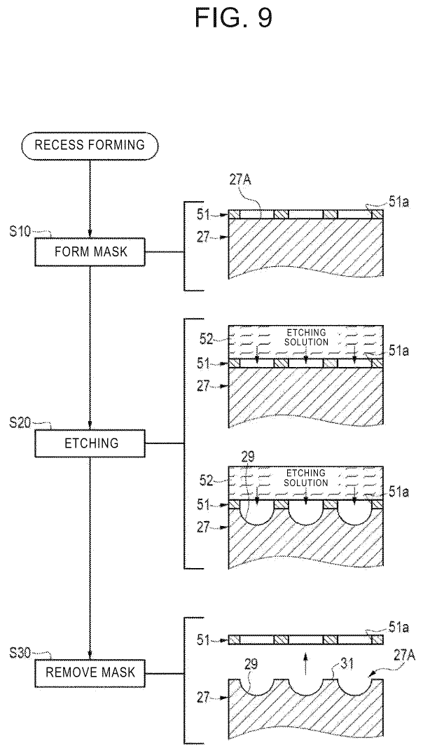

FIG. 9 shows a recess forming process for forming the recesses 29 on the cathode discharge surface 27A. In the present embodiment, the recess forming process is performed by etching as described below as an example. First, in step S10, a photoresist is uniformly applied to the cathode discharge surface 27A of the cathode 27. A mask pattern having the shapes, sizes, and intervals of the large number of recesses 29 is transferred to the applied photoresist by exposure, so that a mask 51 is formed. As a result, the mask 51 having a plurality of holes 51a corresponding to the shapes, sizes, and intervals of the large number of recesses 29 is formed.

In the etching of step S20, an etching solution 52 is sprayed onto the cathode discharge surface 27A on which the mask 51 is formed, and only parts corresponding to the plurality of holes 51a of the mask 51 are etched on the cathode discharge surface 27A. As a result, the large number of recesses 29 corresponding to the arrangement pattern of the holes 51a of the mask 51 are formed on the cathode discharge surface 27A. After the etching of step S20 is completed, the mask 51 is removed from the cathode discharge surface 27A in step S30. Through the recess forming process described above, the large number of recesses 29 are formed on the cathode discharge surface 27A. The recess forming process is an example of the “first process” according to the technology of the present disclosure.

### 2.3 Effect

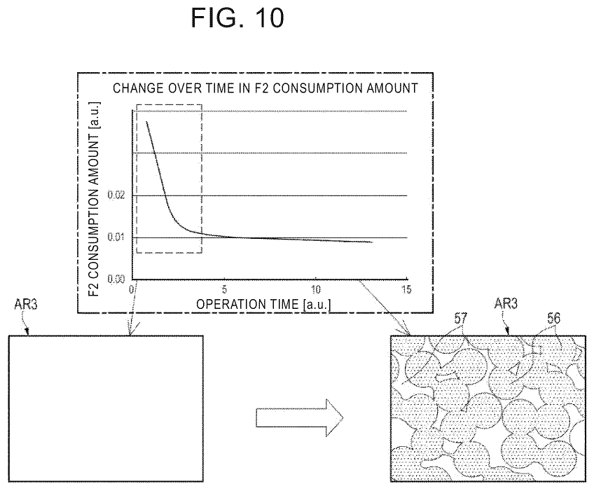

FIG. 10 shows the change over time of the cathode discharge surface 27A which is smooth in the initial state as in the comparative example, in addition to the graph showing the change over time of the fluorine consumption amount shown in FIG. 4. In FIG. 10, a region AR3 shows a region of a part of the smooth cathode discharge surface 27A according to the comparative example, and enlarged views of the region AR3 show states when the gas laser device 2 is actually operated. The enlarged view of the region AR3 on the left side shows a state of the initial stage of operation in which the fluorine consumption is high and the enlarged view of the region AR3 on the right side shows a state of the stable period in which the fluorine consumption is low.

As shown in FIG. 10, even though the cathode discharge surface 27A is a smooth surface at the initial stage of operation, wear of the cathode 27 due to the discharge proceeds, and when the stable period is reached, fine irregularities formed by recesses 56 and convex portions 57 therearound are formed. As described above, in the stable period, the wear amount of the cathode 27 is smaller than that at the initial stage of operation. Considering these results, there is a correlation between the state of the cathode discharge surface 27A and the wear amount of the cathode 27, and it is considered that the wear amount of the cathode 27 decreases when fine irregularities due to the recesses 29 are formed on the cathode discharge surface 27A. In principle, it is presumed that discharge is dispersed in the cathode discharge surface 27A due to fine irregularities and the wear amount of the cathode 27 decreases.

As described above, in the discharge electrode 20 according to the first embodiment, the large number of recesses 29 are formed on the cathode discharge surface 27A in the initial state. Therefore, the state of the cathode discharge surface 27A approaches the state of the stable period in which the wear amount of the cathode 27 is small (see the enlarged view of the region AR3 on the right side in FIG. 10). In this way, since the cathode discharge surface 27A is in the stable period in which the wear amount of the cathode 27 is small even from the initial stage of operation, the wear amount of the cathode 27 at the initial stage of operation decreases. Further, since the wear amount of the cathode 27 decreases, the generation amount of copper or the like bonded to fluorine in the laser gas is also decreased, so that the fluorine consumption amount in the laser gas can be expected to be reduced.

On the other hand, since the anode discharge surface 28A differs in polarity from the cathode discharge surface 27A, it is considered that wear caused by phenomena such as sputtering does not occur. In the anode discharge surface 28A, ionized fluorine in the laser gas is sucked due to the polarity. As a result, fluorine enters the anode discharge surface 28A, and the anode discharge surface 28A is directly fluorinated. Therefore, for the anode discharge surface 28A, the recesses 29 for reducing the wear amount of the anode 28 are not required. Further, when the recesses 29 are formed on the anode discharge surface 28A, the surface area of the anode discharge surface 28A increases, and thus the area to be fluorinated may also increase. As the fluoridation of the anode discharge surface 28A proceeds, the lifetime thereof also decreases. Therefore, since the recesses 29 are not formed on the anode discharge surface 28A, it is possible to suppress a decrease in the lifetime of the anode discharge surface 28A. More preferably, the anode discharge surface 28A has no recess 29 and is a smooth surface having the surface roughness Ra smaller than 25 as in the present embodiment. As a result, the surface area of the anode discharge surface 28A is further decreased as compared with the case in which the surface roughness Ra is 25 or larger, and thus it is possible to further suppress a decrease in the lifetime.

Further, as for the recesses 29 of the cathode discharge surface 27A, the range of the diameter DM of 20 to 100 μm, the range of the depth DP of 5 to 30 μm, and the number per unit area of 1000 pieces/mm² or more, preferably 3000 pieces/mm² or more are close to the size and number of the recesses 56 in the stable period (see the enlarged view of the region AR3 on the right side in FIG. 10). As a result, the state of the cathode discharge surface 27A can be brought closer to the state of the stable period, so that further reduction of the wear amount of the cathode 27 at the initial stage of operation can be expected.

Further, by arranging the recesses 29 regularly, it is possible to suppress concentration of the electric field. As the concentration of the electric field proceeds, arc discharge may occur. By suppressing the concentration of the electric field, occurrence of arc discharge can be suppressed, and the stability of discharge is improved. Further, by forming the recesses 29 over the entire region of the cathode discharge surface 27A, the concentration of the electric field can be further suppressed. Thus, the stability of discharge is further improved. Further, since the concentration of the electric field is suppressed, local variation of wear of the cathode in the cathode discharge surface 27A can be expected to be decreased.

Further, by forming the inner peripheral surface 29a of the recess 29 to have a curved shape, it is possible to further suppress the concentration of the electric field as compared with a shape in which the sectional shape has a corner such as a triangle, for example. Thus, the stability of discharge is further improved.

As a forming method of the recesses 29, a forming method by etching shown in FIG. 9 has been exemplified, but a method other than etching may be adopted. For example, the recesses 29 may be formed by a method such as sand blasting, laser machining, and electric discharge machining. However, when the recesses 29 are formed by sandblasting or the like, the inner peripheral surface 29a of each recess 29 may be likely to have a corner instead of having a curved shape. If the inner peripheral surface 29a has a corner, discharge may become unstable. Therefore, etching is preferable as the forming method of the recesses 29.

### 2.4 Modification of First Embodiment

### 2.4.1 First Modification (Surface Shape of Cathode Discharge Surface)

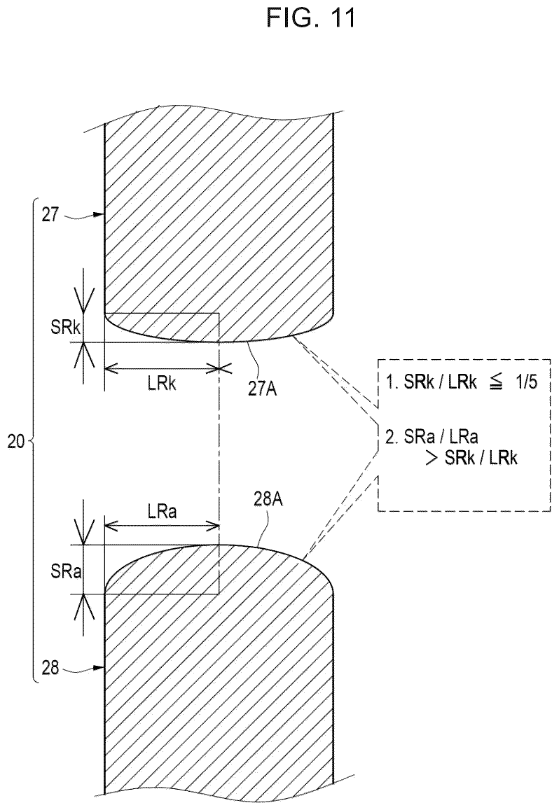

The example shown in FIG. 11 is an example in which the overall surface shape of the cathode discharge surface 27A is a curved surface convexed toward the anode discharge surface 28A in the width direction perpendicular to the longitudinal direction. Further, in the present embodiment, the sectional shape of the cathode discharge surface 27A in the width direction is an elliptical shape having an aspect ratio of ⅕ or less, which is the ratio of the minor radius to the major radius. That is, as shown in FIG. 11, when the minor radius of the ellipse of the cathode discharge surface 27A is SRk and the major radius is LRk, the overall surface shape of the cathode discharge surface 27A satisfies SRk/LRk≤1/5. For example, SRk/LRk is about 1/8.

Here, the overall surface shape refers to an outer shape when the sectional shape is viewed macroscopically without considering fine irregularities such as the recesses 29. Although fine irregularities due to the recesses 29 are formed on the cathode discharge surface 27A according to the first modification as well when viewed microscopically, the fine irregularities are not shown in FIG. 11.

### 2.4.1.1 Relationship Between Surface Shape of Cathode Discharge Surface and Wear Amount of Cathode

The overall surface shape of the cathode discharge surface 27A is curved as being convexed with a large curvature at the initial stage of operation, but becomes curved as being convexed with a small curvature in the stable period in which the wear amount of the cathode 27 is small, and approaches planar. In principle, when the cathode discharge surface 27A is a convex curved surface having a small curvature, it is presumed that discharge tends to concentrate on the convex portion, wear of the convex portion proceeds, and the cathode discharge surface 27A approaches to be planar. Therefore, it is considered that, by setting the overall shape of the cathode discharge surface 27A close to planar even at the initial stage of operation, the wear amount of the cathode 27 at the initial stage of operation can be decreased. As shown in FIG. 11, by setting the overall surface shape of the cathode discharge surface 27A to a convex curved surface having a small curvature, it is possible to decrease the wear amount of the cathode 27 at the initial stage of operation.

Here, the cathode discharge surface 27A may be planar instead of being curved. Even in this case, it is possible to decrease the wear amount of the cathode 27 at the initial stage of operation. However, in the case of being planar, corners tend to stand at both end portions of the cathode discharge surface 27A in the width direction, so that there is a case that discharge concentrates at the portions. Therefore, the cathode discharge surface 27A is preferably a convex curved surface having a small curvature as shown in FIG. 11.

### 2.4.1.2 Relationship Between Surface Shape of Cathode Discharge Surface and Surface Shape of Anode Discharge Surface

Further, as shown in FIG. 11, similarly to the cathode discharge surface 27A, it is preferable that the overall surface shape of the anode discharge surface 28A is a curved surface convexed toward the cathode discharge surface 27A in the width direction and has an elliptical sectional shape. Further, in the anode discharge surface 28A, the aspect ratio of the ellipse is preferably larger than the aspect ratio of the ellipse of the cathode discharge surface 27A. That is, as shown in FIG. 11, when the minor radius of the ellipse of the anode discharge surface 28A is SRa and the major radius is LRa, SRa/LRa>SRk/LRk is preferably satisfied. The reason is as follows.

In the cathode discharge surface 27A and the anode discharge surface 28A, when both surface shapes are close to planar, corners tend to stand at both end portions in the width direction. Then, it is considered that discharge tends to concentrate at the corners and discharge tends to become unstable. When discharge becomes unstable, the beam profile of the pulse laser light PL may become uneven, or the wear amount of the discharge electrode 20 may increase. As described above, from the viewpoint of reducing the wear amount of the cathode 27, it is preferable to bring the cathode discharge surface 27A closer to being planar. A convex curved surface having a curvature larger than that of the cathode discharge surface 27A is preferable, from the viewpoint of securing stability of discharge, for the anode discharge surface 28A used in combination with the cathode discharge surface 27A thus close to being planar. For example, when the aspect ratio (SRk/LRk) of the ellipse of the cathode discharge surface 27A is 1/5 or less, the aspect ratio (SRa/LRa) of the ellipse of the anode discharge surface 28A is about 2/3.

### 2.4.2 Second Modification (Coating on Recess)

### 2.4.2.1 Configuration and Effect of Coating Layer

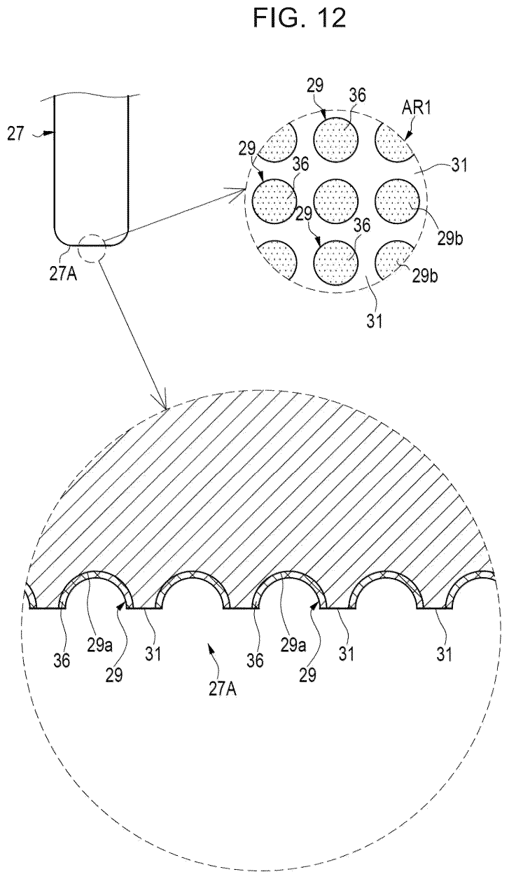

A coating layer 36 may be formed on each of the recesses 29 as a modification shown in FIG. 12. The material of the coating layer 36 is a material being a high-resistance material having higher electrical resistance than the material of the cathode 27 or an insulating material, and having low reactivity with fluorine. As such a material, for example, fluoride such as copper fluoride (CuF₂) or nickel fluoride (NiF₂) is preferable. Alternatively, the material may be a ceramic such as alumina (Al₂O₃) or zirconia (ZrO₂) having low reactivity with fluorine. In the cathode discharge surface 27A, to secure a discharge region, the coating layer 36 is formed only on the inner peripheral surfaces 29a of the recesses 29 and is not formed on the convex portions 31 around the recesses 29.

In the cathode discharge surface 27A, since the electrical resistance of the coating layer 36 is larger than that of the convex portions 31, discharge at the recesses 29 is suppressed, and discharge occurs at the convex portions 31. Since discharge at the recesses 29 is suppressed, the wear amount of the cathode 27 can be further decreased. Further, when discharge occurs at the recesses 29, discharge may be non-uniform. By forming the coating layer 36 at each of the recesses 29 and limiting the occurrence position of discharge to the convex portions 31, stability of discharge can be expected to be improved.

### 2.4.2.2 Forming Method of Coating Layer

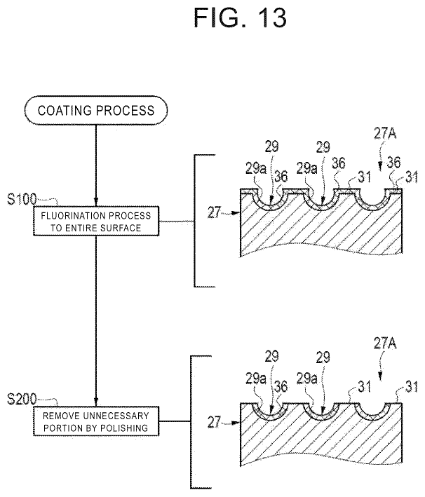

For example, the coating layer 36 is formed by a coating process shown in FIG. 13. The coating process shown in FIG. 13 is an example in which fluoride is used as the material of the coating layer 36. As shown in FIG. 13, the coating process includes step S100 of subjecting the entire surface of the cathode discharge surface 27A to a fluorination process, and step S200 of removing the coating layer 36 on the convex portions 31 as unnecessary portions by polishing. As a result, the coating layer 36 can be formed on the inner peripheral surfaces 29a of the recesses 29. The coating process is an example of the “second process” according to the technology of the present disclosure.

### 3. Second Embodiment

### 3.1 Configuration

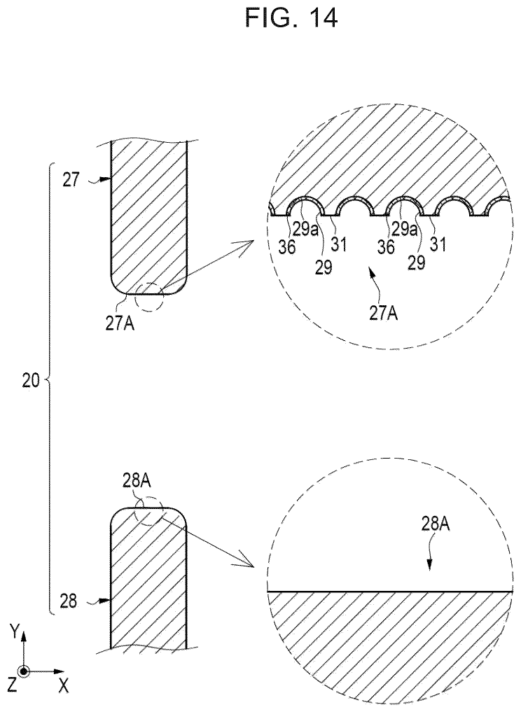

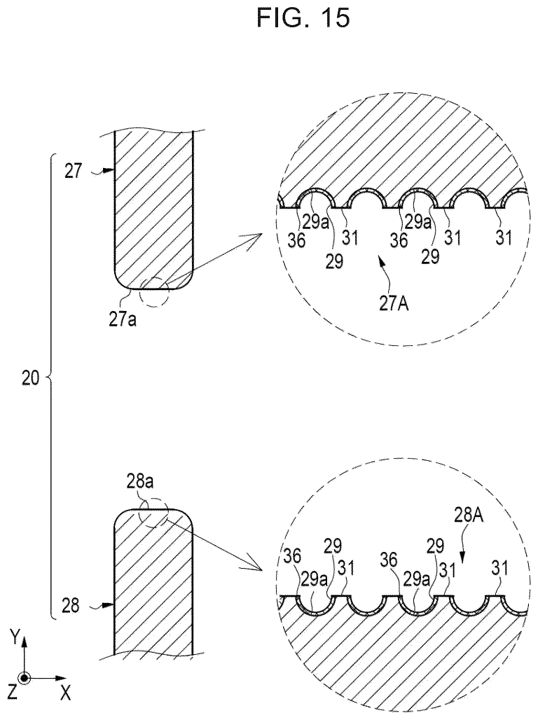

Next, the discharge electrode 20 according to a second embodiment shown in FIGS. 14 and 15 will be described. The discharge electrode 20 according to the second embodiment is similar to the discharge electrode 20 according to the first embodiment in that the recesses 29 are provided on the cathode discharge surface 27A. Further, in the second embodiment, the size and the number of the recesses 29, the shape of the inner peripheral surfaces 29a of the recesses 29, the overall surface shape of the cathode discharge surface 27A, and the like are also similar to those in the first embodiment.

The first difference between the discharge electrode 20 according to the first embodiment and the discharge electrode 20 according to the second embodiment is that the coating layer 36 formed on the recesses 29 is arbitrary in the discharge electrode 20 according to the first embodiment, whereas the coating layer 36 is an essential configuration in the discharge electrode 20 according to the second embodiment.

The second difference is that, in the discharge electrode 20 according to the first embodiment, it is essential that the recesses 29 are not formed on the anode discharge surface 28A, whereas in the discharge electrode 20 according to the second embodiment, forming the recesses 29 on the anode discharge surface 28A is arbitrary. The example shown in FIG. 14 is an example in which the recesses 29 are not formed on the anode discharge surface 28A, and the example shown in FIG. 15 is an example in which the recesses 29 are formed on the anode discharge surface 28A. Of course, the anode discharge surface 28A may be provided with recesses 29 different in size or number from the recesses 29 on the cathode discharge surface 27A. Further, in the second embodiment, the surface roughness Ra of the anode discharge surface 28A may also be 25 or more. That is, in the discharge electrode 20 according to the second embodiment, the anode discharge surface 28A may have any form.

### 3.2 Manufacturing Method for Discharge Electrode

The manufacturing method for the discharge electrode 20 according to the second embodiment is similar to the manufacturing method for the discharge electrode 20 according to the first embodiment and the modifications thereof shown in FIGS. 9 and 13, for example.

### 3.3 Effect

In the discharge electrode 20 according to the second embodiment, the effect of the large number of recesses 29 and the coating layer 36 formed on the cathode discharge surface 27A are similar to the effect described in the modification of the first embodiment shown in FIG. 12.

### 4. OTHER MODIFICATION

Although the gas laser device 2 in which the discharge electrode 20 according to the first and second embodiments is used is a line narrowing laser device, the present invention is not limited thereto, and a gas laser device that outputs natural oscillation light may be used. For example, a high reflection mirror may be arranged in place of the line narrowing module 15.

Further, although the gas laser device 2 is an excimer laser device in the first and second embodiments, instead of this, an F2 molecular laser device using a laser gas containing a fluorine gas and a buffer gas may be adopted. That is, the gas laser device 2 according to the present disclosure may be any gas laser device that excites a laser gas containing fluorine by discharge.

### 5. MANUFACTURING METHOD FOR ELECTRONIC DEVICE

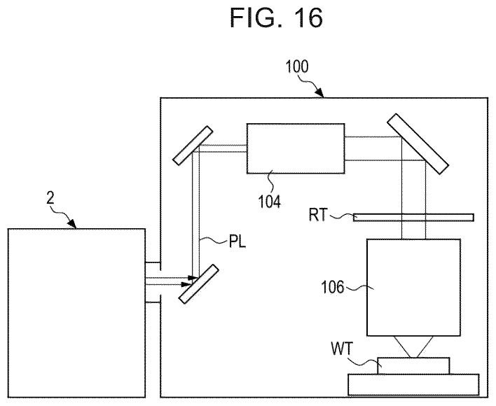

FIG. 16 schematically shows a configuration example of the exposure apparatus 100. The exposure apparatus 100 includes an illumination optical system 104 and a projection optical system 106. For example, the illumination optical system 104 illuminates a reticle pattern of a reticle (not shown) arranged on a reticle stage RT with the pulse laser light PL incident from the gas laser device 2. The projection optical system 106 causes the pulse laser light PL transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 100 synchronously translates the reticle stage RT and the workpiece table WT to expose the workpiece to the pulse laser light PL reflecting the reticle pattern. After the reticle pattern is transferred onto the semiconductor wafer by the exposure process described above, a semiconductor device can be manufactured through a plurality of processes. The semiconductor device is an example of the “electronic device” in the present disclosure.

The discharge electrode 20 according to the first embodiment or the second embodiment is used in the gas laser device 2 shown in FIG. 16.

Here, not limited to the manufacturing of an electronic device, the gas laser device 2 may be used for laser processing such as drilling.

The description above is intended to be illustrative and the present disclosure is not limited thereto. Therefore, it would be obvious to those skilled in the art that various modifications to the embodiments of the present disclosure would be possible without departing from the spirit and the scope of the appended claims.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. A discharge electrode to be used in a gas laser device for exciting a laser gas containing fluorine by discharge, comprising:
a cathode having an elongated cathode discharge surface; and
an anode having an elongated anode discharge surface and arranged in a posture in which the anode discharge surface faces the cathode discharge surface,
a large number of recesses being formed on the cathode discharge surface in an initial state, and a large number of recesses not being formed on the anode discharge surface in the initial state.

2. The discharge electrode according to claim 1,
wherein the recesses each have a diameter of 20 to 100 μm and a depth of 5 to 30 μm.

3. The discharge electrode according to claim 1,
wherein the number of the recesses is 1000 pieces/mm² or more.

4. The discharge electrode according to claim 3,
wherein the number of the recesses is 3000 pieces/mm² or more.

5. The discharge electrode according to claim 1,
wherein the recesses are regularly arranged.

6. The discharge electrode according to claim 1,
wherein the recesses are formed in an entire region of the cathode discharge surface.

7. The discharge electrode according to claim 1,
wherein an inner peripheral surface of each of the recesses has a curved shape.

8. The discharge electrode according to claim 1,
wherein the anode discharge surface is a smooth surface having a surface roughness Ra smaller than 25.

9. The discharge electrode according to claim 1,
wherein an overall surface shape of the cathode discharge surface is curved as being convexed toward the anode discharge surface in a width direction orthogonal to a longitudinal direction, and a sectional shape in the width direction is an elliptical shape having an aspect ratio of 1/5 or less, which is a ratio of a minor radius to a major radius.

10. The discharge electrode according to claim 9,
wherein an overall surface shape of the anode discharge surface is curved as being convexed toward the cathode discharge surface in the width direction, and a sectional shape in the width direction is an elliptical shape, and
an aspect ratio of the elliptical shape of the anode discharge surface is larger than the aspect ratio of the elliptical shape of the cathode discharge surface.

11. The discharge electrode according to claim 1,
wherein a surface shape of the cathode discharge surface is planar.

12. The discharge electrode according to claim 1,
wherein a coating layer is formed on the recesses.

13. The discharge electrode according to claim 12,
wherein the coating layer is formed of fluoride.

14. A discharge electrode to be used in a gas laser device for exciting a laser gas containing fluorine by discharge, comprising:
a cathode having an elongated cathode discharge surface; and
an anode having an elongated anode discharge surface and arranged in a posture in which the anode discharge surface faces the cathode discharge surface,
a large number of recesses being formed on the cathode discharge surface in an initial state, and a coating layer being formed on the recesses.

15. The discharge electrode according to claim 14,
wherein the coating layer is formed of fluoride.

16. The discharge electrode according to claim 14,
wherein the recesses each have a diameter of 20 to 100 μm and a depth of 5 to 30 μm.

17. The discharge electrode according to claim 14,
wherein the number of the recesses is 1000 pieces/mm² or more.

18. The discharge electrode according to claim 14,
wherein the number of the recesses is 3000 pieces/mm² or more.

19. The discharge electrode according to claim 14,
wherein the recesses are regularly arranged.

20. The discharge electrode according to claim 14,
wherein the recesses are formed in an entire region of the cathode discharge surface.

21. The discharge electrode according to claim 14,
wherein a concave surface of each of the recesses has a curved shape.

22. The discharge electrode according to claim 14,
wherein an overall surface shape of the cathode discharge surface is curved as being convexed toward the anode discharge surface in a width direction orthogonal to a longitudinal direction, and a sectional shape in the width direction is an elliptical shape having an aspect ratio of 1/5 or less, which is a ratio of a minor radius to a major radius.

23. The discharge electrode according to claim 14,
wherein a surface shape of the cathode discharge surface is planar.

24. A manufacturing method for a discharge electrode, comprising:
a first process of forming a large number of recesses on an elongated cathode discharge surface; and
a second process of forming a coating layer on an inner peripheral surface of each of the recesses,
the discharge electrode to be used in a gas laser device for exciting a laser gas containing fluorine by discharge, including:
a cathode having the cathode discharge surface; and
an anode having an elongated anode discharge surface and arranged in a posture in which the anode discharge surface faces the cathode discharge surface.

25. The manufacturing method for a discharge electrode according to claim 24,
wherein the recesses are formed by etching in the first process.

26. A manufacturing method for an electronic device, comprising:
generating laser light using a gas laser device in which a laser gas including fluorine is excited by discharge using a discharge electrode;
outputting the laser light to an exposure apparatus; and
exposing a photosensitive substrate to the laser light in the exposure apparatus to manufacture an electronic device,
the discharge electrode including:
a cathode having an elongated cathode discharge surface; and
an anode having an elongated anode discharge surface and arranged in a posture in which the anode discharge surface faces the cathode discharge surface,
a large number of recesses being formed on the cathode discharge surface in an initial state, and a large number of recesses not being formed on the anode discharge surface in the initial state.

27. A manufacturing method for an electronic device, comprising:
generating laser light using a gas laser device in which a laser gas including fluorine is excited by discharge using a discharge electrode;
outputting the laser light to an exposure apparatus; and
exposing a photosensitive substrate to the laser light in the exposure apparatus to manufacture an electronic device,
the discharge electrode including:
a cathode having an elongated cathode discharge surface; and
an anode having an elongated anode discharge surface and arranged in a posture in which the anode discharge surface faces the cathode discharge surface,
a large number of recesses being formed on the cathode discharge surface in an initial state, and a coating layer being formed on the recesses.
